(19) United States
(12) Patent Application Publication
(10) Pub. No.: US 2015/0287001 A1
(43) Pub. Date: Oct. 8, 2015

(54) ELECTRONIC BILL PAYMENT PROCESSING BASED ON PAYOR SCHEDULED DEBITS

(71) Applicant: FISERV, INC., Brookfield, WI (US)

(72) Inventors: Todd A. Weiss, Atlanta, GA (US); Mary Elizabeth Lawson, Westerville, OH (US); Eric Anthony Miller, Suwanee, GA (US)

(21) Appl. No.: 14/741,623

(22) Filed: Jun. 17, 2015

Related U.S. Application Data
(63) Continuation of application No. 14/015,541, filed on Aug. 30, 2013.
(60) Provisional application No. 61/802,120, filed on Mar. 15, 2013.

(51) Int. Cl. G06Q 20/10; G06Q 20/26

(52) U.S. Cl. CPC G06Q 20/102; G06Q 20/26

(57) ABSTRACT

Systems, methods, and computer-readable media are disclosed for facilitating enrollment of a payor for payor-scheduled-debit (PSD) payment processing according to which the payor may select various payment parameters such as a debit date on which debits will be posted to one or more financial accounts associated with the payor for payments made to one or more payees. A payor may be provided with the capability to schedule debits associated with payments made to one or more payees by a selecting a single debit date that precedes and/or follows various dates on which the one or more payees are credited.

### CROSS-REFERENCE TO RELATED APPLICATION(S)

This application is a continuation of U.S. application Ser. No. 14/015,541, filed Aug. 30, 2013, which claims the benefit of U.S. Provisional Application No. 61/802,120, filed Mar. 15, 2013, the contents of which are incorporated by reference herein in their entireties.

### BACKGROUND

An electronic bill presentment and payment (EBPP) service provider may offer functionality that supports the electronic presentment and/or payment of bills to a payee. The bills may be associated with charges incurred by the payee with any of a variety of electronic and/or non-electronic billers. Payment dates associated with bills of certain billers may be established in accordance with a regular payment cycle. For example, for a particular biller, a payment date for recurring charges billed to a payor may occur on approximately the same date of a billing cycle (e.g., a monthly billing cycle) and may be dictated by a billing period associated with the recurring charges.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar or identical items; however, different reference numerals may be used to indicate similar or identical items as well. Various embodiments may utilize element(s) and/or component(s) other than those illustrated in the drawings and some element(s) and/or component(s) may not be present in various embodiments. It should be appreciated that while singular terminology may be used to describe a component or element, a plural number of such components or elements may also be encompassed within the scope of the disclosure.

FIG. 1 is a schematic block diagram of an illustrative system architecture that facilitates enrollment of a payor for payor-scheduled-debit payment processing as well as for processing of a payment request associated with a payor enrolled for payor-scheduled-debit payment processing in accordance with one or more embodiments of the disclosure.

FIG. 2 is a more detailed schematic block diagram illustrating various hardware and software sub-components of various components of the illustrative system architecture of FIG. 1 in accordance with one or more embodiments of the disclosure.

FIGS. 3A-3C depict various illustrative payor-scheduled-debit bill payment schedules according to which a billing period associated with one or more payees predates, follows, or straddles a debit date in accordance with one or more embodiments of the disclosure.

FIG. 4A-4C are process flow diagrams of illustrative functionality associated with enrollment of a payor for payor-scheduled-debit bill payment processing in accordance with one or more embodiments of the disclosure.

FIGS. 5A-5B are process flow diagrams of illustrative functionality associated with payment request processing in accordance with one or more embodiments of the disclosure.

### DETAILED DESCRIPTION

### Overview

Embodiments of the disclosure relate to, among other things, systems, methods, computer-readable media, techniques and methodologies for facilitating enrollment of a payor for payor-scheduled-debit (PSD) payment processing. As used herein, the phrase “payor-scheduled-debit payment processing,” “payor-scheduled-debit bill payment processing,” “PSD payment processing,” “PSD bill payment processing,” or any variations thereof may refer to a type of payment processing for which a payor may be enrolled based on various eligibility, risk analysis, and pricing determinations, and according to which, the payor may select various payment parameters such as a debit date on which debits will be posted to one or more financial accounts associated with the payor for payments made to one or more payees. In accordance with one or more embodiments of the disclosure, a payor enrolled for PSD payment processing may be provided with the capability to schedule debits associated with payments made to one or more payees by a selecting a single debit date that precedes and/or follows various dates on which the one or more payees are credited. A payor enrolled for PSD payment processing may be able to select a debit date based on cash inflows for the payor, and thereby ensure that sufficient funds are continually available to the payor.

PSD payment processing may be supported for any of variety of types of payees including payees that may be paid in accordance with a regular payment cycle including, but not limited to, an electronic biller, a billing and/or non-billing payee associated with recurring payments, a billing and/or non-billing payee receiving payments (e.g., “singleton” payments) in accordance with a regular payment cycle, and so forth. Payees in accordance with various embodiments of the disclosure may include managed payees or unmanaged payees. Managed payees may include payees having a pre-existing relationship with a service provider such as an EBPP service provider. A variety of types of information associated with a managed payee may be available to the EBPP service provider in order to optimize bill presentment and/or payment services provided to the payee by the service provider. Such information may include, for example, identification of a 3^{rd}-party remittance processor servicing the payee, remittance center addresses, financial account information for financial accounts associated with the payee, specified remittance advice formats, account schemes and alteration rules, and so forth. On the other hand, an unmanaged payee may refer to a payee for whom an EBPP service provider does not have access to additional information pertaining to the payee beyond that which may be supplied to the service provider by the payor. An unmanaged payee may typically be a smaller entity than a managed payee. Managed payees may include both electronic managed payees that can be credited electronically, and optionally, may be capable of receiving remittance advice electronically as well as non-electronic payees for whom the service provider does not have any information to enable electronic crediting. An electronic managed payee may also be an electronic biller that delivers billing information to an EBPP service provider for electronic presentment by the service provider.

More specifically, payees that are potential candidates for PSD payment processing may include, but are not limited to, a non-billing payee that receives a “singleton” payment from a payor on approximately the same date each month (e.g., a charitable organization, etc.), an electronic biller that receives a payment manually initiated by a payor on approximately the same date each month in accordance with a monthly billing cycle (e.g. a wireless service provider, a credit card issuer, etc.), a biller (which may be a non-electronic biller) that receives a fixed amount payment on the same date each month in accordance with an established recurring payment schedule (e.g., a lender that receives loan payments, etc.), an electronic biller that receives a payment on approximately the same date each month in accordance with an automatic payment (autopay) enrollment of the payor for payment of electronic bills of the biller (e.g., an insurance provider, a credit card issuer, etc.), a non-electronic biller that receives a “singleton” payment on approximately the same date each month in accordance with a monthly billing cycle (e.g., a utility company, etc.), and so forth. As used herein, the term “singleton payment” may refer to a one-time payment of a fixed or variable amount that may be manually initiated by a payor. Payees that are potential candidates for PSD payment processing may further include payees that receive person-to-person (P2P) payments, on a singleton basis or as part of a regular payment schedule. As used herein, the term “regular payment cycle” may refer to a payment cycle that has a certain periodicity associated therewith.

While embodiments of the disclosure may be described in the context of billers or non-billing payees that receive payments in accordance with a monthly payment cycle, it should be appreciated that embodiments of the disclosure may extend to billers or non-billing payees that receive payments in accordance with payment cycles that are less than or greater than one month as well as payees that are paid irregularly (e.g., not in accordance with a regular payment cycle). As will be described in greater detail hereinafter, in accordance with one or more embodiments of the disclosure, a payor may be able to request that a particular “singleton” payment request (that may be associated with a payee that is typically paid in accordance with an irregular payment schedule) be processed in accordance with an established PSD payment schedule associated with the payor. Such a payment request may potentially require an incremental fee.

In accordance with one or more embodiments of the disclosure, a payor enrolled for PSD payment processing may establish a PSD payment schedule according to which payment amounts for payments made to a wide variety of payees are debited on a same payor-selected date each month (from one or more financial accounts) even though the payments may be credited to the payees on different dates that may precede and/or follow the debit date. While a payor may select a particular debit date each month on which payment amounts associated with payments to payees may be debited, the respective payments may be made to various payees as scheduled, as either a payment manually initiated by the payor, a payment made in accordance with a recurring payment schedule (e.g., a monthly charitable contribution), a payment made automatically in response to issuance of an electronic bill (e.g., an autopay payment), and so forth.

While embodiments of the disclosure may be described in the context of a payor-selected debit date corresponding to a particular date each month, it should be appreciated that such embodiments may encompass alternative payor-selected timing parameters for debits. For example, a payor may specify a timing of debits that corresponds to a specific day of a specific week each month (e.g., the second Friday of each month). As another non-limiting example, the payor may designate an initial debit date and a recurring debit pattern based on the designated initial debit date (e.g., every X number of weeks thereafter). Certain payor-selected debit timing patterns may support PSD payment schedules having a frequency greater than a frequency associated with selection of a debit date each month. Accordingly, certain payor-selected debit timing patterns may support, for example, pay schedules that may have an associated frequency that is greater than semi-monthly (e.g., weekly pay schedules, bi-weekly pay schedules, or the like).

In addition to selecting a debit date or an alternative debit pattern for the posting of debits associated with PSD payment processing, a payor may also be afforded the opportunity to select a bill period for determining payees to include in the PSD payment schedule established for the payor. Various scenarios are possible for selection of the bill period. For example, the payor may select a bill period that precedes the debit date. In such a scenario, payees may be paid before payment amounts are debited from one or more financial accounts associated with the payor. A variety of risk analysis processing and pricing determinations may be made under such a scenario. Illustrative factors that may be taken into consideration for each respective potential candidate payee as part of risk processing and/or pricing determinations for such a scenario may include for example: the number of days that the payee will be paid in advance of the debit date, a maximum payment amount for the payee, and so forth. In addition, various aggregate factors for all payees may be considered such as, for example, the sum of the days paid in advance across all payees, the sum of the maximum payment amounts across all payees, available information pertaining to other obligations of the payor (e.g., other payment obligations associated with bills received by the payor, payments that have already been scheduled, payment history information, available online banking or core account information such as account balances associated with financial accounts held by the payor, etc.), and so forth. A variety of additional factors may also be considered as part of the risk processing and/or pricing determinations such as, for example, a credit worthiness of the payor, historical payment patterns, and so forth.

In another illustrative scenario, the bill period selected by the payor may be subsequent to the selected debit date. In such a scenario, payment amounts associated with payments made to payees may be debited from financial account(s) held by the payor on a debit date that is prior to dates on which the payment amounts are credited to respective payees. In such a scenario, minimal, if any, risk analysis processing may be performed (other than potentially standard risk analysis associated with payment processing) and the pricing of the PSD payment schedule under this scenario may be correspondingly lower than the pricing associated with the scenario in which the bill period precedes the debit date.

In yet another illustrative scenario, the bill period selected by the payor may include a first portion that precedes the debit date and a second portion that follows the debit date. Under such a scenario, certain payees may be credited prior to the debit date while certain other payees may be credited subsequent to the debit date. Accordingly, such a scenario may encompass aspects of one or both of the other scenarios previously described. For those payees that are to be credited prior to the debit date, the more involved risk analysis processing described above in connection with the scenario in which the entire bill period precedes the debit date may be performed and the pricing may be correspondingly higher. For those payees that are to be credited subsequent to the debit date, the standard risk processing described above in connection with the scenario in which the entire bill period follows the debit date may performed (or not performed at all) and the pricing may be correspondingly lower. In certain embodiments, pricing may be determined on a per-payee basis, while in other embodiments, pricing may be determined on an aggregate basis for all payees to be paid in accordance with an established PSD payment schedule associated with a payor. In certain embodiments, pricing associated with the scenario that involves a bill period that straddles the debit date may be intermediate to pricing associated with the other two scenarios described above.

It should be appreciated that the above scenarios are merely illustrative and not exhaustive and that numerous variations are within the scope of this disclosure. For example, while embodiments of the disclosure may be described in the context of a single PSD payment schedule for a payor, in certain embodiments, a payor may be provided with the capability to establish multiple PSD payment schedules. For example, a payor may establish a first PSD payment schedule associated with a first debit date and a second PSD payment schedule associated with a second debit date. The establishment of multiple PSD payment schedules associated with different respective debit dates may be advantageous in scenarios in which the payor has multiple cash inflows during a particular time period (e.g., a month).

In one or more embodiments of the disclosure, a payment system comprising various subsystems may be provided for facilitating the enrollment of a payor in PSD payment processing. The payment system may further support functionality for determining whether received payment requests satisfy various payment parameters associated with a PSD payment schedule established for a payor and either performing PSD payment processing in accordance with the established PSD payment schedule if the payment parameters are determined to be satisfied, or providing one or more alternative options to the payor for processing the payment request. While embodiments of the disclosure may be described in the context of PSD enrollment and payment processing functionality that may be supported by the payment system, it should be appreciated that the payment system is capable of supporting a wide variety of functionality such as various aspects of EBPP functionality including, but not limited to, enrollment of payors for electronic bill presentment and/or payment, payee/biller setup, transactional support, payment request processing (e.g., risk-based payment request processing, good funds payment processing, etc.), communication with payment networks (e.g., transmission of debit and/or credit instructions to a wide variety of types of payment networks, remittance advice generation and transmission, biller activation, bill/invoice processing, etc.), and so forth.

In certain embodiments, the payment system may be an electronic bill presentment and payment (EBPP) system that supports functionality for the presentment of electronic bills and/or the processing of electronic payments associated with bills including electronic and/or paper bills. The payment system may be hosted by a financial service provider such as a third-party financial service provider providing payment system functionality on behalf of a financial institution, a financial service provider providing payment system functionality as part of a consumer-direct scenario, and so forth. In other embodiments, the payment system may be hosted by a financial institution, or the like. While functionality described herein may be provided by a system capable of supporting both electronic bill payment as well as electronic presentment of bills, electronic bill presentment functionality is not required and in various embodiments, the payment system may only support functionality for processing electronic payments. Further, it should be appreciated that the PSD payment processing described herein may involve the processing of payments to payees that are not billers (e.g., non-billing payees (e.g., charitable organizations, individual payees, etc.).

Further, in certain embodiments, functionality supported by the payment system may be offered in the context of financial institution sponsorship or in a context in which online banking or core account information associated with a payor is available to the payment system. In such contexts, the availability of online banking and/or core account information may facilitate risk processing and/or lead to reduced pricing. However, embodiments of the disclosure do not require financial institution sponsorship or the availability of online banking and/or core account information, and may be provided in other contexts such as, for example, as a consumer-direct solution.

The payment system may be configured to communicate with one or more payor devices over one or more networks, which may be include any suitable public or private networks including cellular networks, the Internet, and so forth. The payor device(s) may be operable by one or more payors. The payment system may be further configured to communicate via one or more networks with one or more payee computers associated with one or more payees optionally including any one or more electronic billing payees, non-electronic-billing payees, non-billing payees, and so forth. In addition, the payment system may be configured to communicate with one or more financial institution systems via one or more payment networks. For example, the payment system may generate and transmit debit and/or credit instructions for posting associated debits and/or credits, respectively, to financial accounts held at various financial institutions. The payment networks may include any suitable networks, including but not limited to, a debit network, a credit network, an Automated Clearinghouse (ACH) network, a proprietary network of financial institutions, and so forth.

As previously noted, the payment system may include various subsystems such as, for example, a PSD payment enrollment subsystem and a PSD payment request processing subsystem. Each subsystem may, in turn, include one or more payment computers of the payment system. Various program modules may be executable on the respective payment computer(s) forming part of each subsystem. For example, an eligibility determination module, a payment parameter(s) identification/selection module, a candidate payee(s) identification/selection module, a risk processing module, a pricing module, and a PSD payment schedule proposal generation module may be provided as part of the PSD payment enrollment subsystem. In addition, a PSD payment processing eligibility determination module, a PSD payment processing module, an overage funds transfer module, and a payment request modification module may be provided as part of the PSD payment processing subsystem.

In various embodiments, the various program modules of the PSD payment enrollment subsystem may support respective functionality associated with various aspects of the processing for establishing a PSD payment schedule for a payor. Such processing may include, but is not limited to, determining whether a payor is eligible for establishment of a PSD payment schedule based on payment history information associated with the payor and various eligibility conditions, determining candidate payees for receipt of payments in accordance with a PSD payment schedule, identifying various payment parameters selected by the payor for association with a PSD payment schedule, performing risk processing and pricing determination processing to price the PSD payment schedule, generating a PSD payment schedule proposal, and ultimately generating the PSD payment schedule based on an indication of approval received on behalf of the payor.

Further, in various embodiments, the various program modules of the PSD payment processing subsystem may support respective functionality associated with various aspects of the processing a payment in connection with a PSD payment schedule. Such processing may include, but is not limited to, identifying a payment request, determining whether the payment request satisfies payment parameters associated with an established PSD payment schedule, determining whether exceptions handling processing (e.g., an overage funds transfer) is capable of resolving discrepancies between the payment request and the payment parameters of a PSD payment schedule, and if any such discrepancies cannot be resolved through exceptions handling processing, generating and transmitting for presentation to the payor various alternate options for proceeding with processing of the payment request.

The respective functionality that may be supported by each of the program modules of the various subsystems of the payment system will be described in more detail later in this disclosure. It should be appreciated that the program modules described above are merely illustrative and that a fewer number, a greater number, or different program modules capable of supporting the same, similar, or different functionality may be provided. Further, the subsystems described above are also merely illustrative and additional subsystems capable of supporting at least a portion of the functionality described above or additional functionality may be provided in various embodiments. In addition, in certain embodiments, functionality supported by any of the program modules of the payment system may be distributed among multiple payment system computers and multiple subsystems of the payment system may include one or more shared payment system computers configured to support at least a portion of the respective functionality supported by each of the subsystems (or more specifically functionality supported by respective program module(s) of each of the subsystems).

One or more illustrative embodiments of the disclosure have been described above. These and other embodiments of the disclosure will be described in more detail hereinafter through reference to accompanying drawings.

### Illustrative Architecture

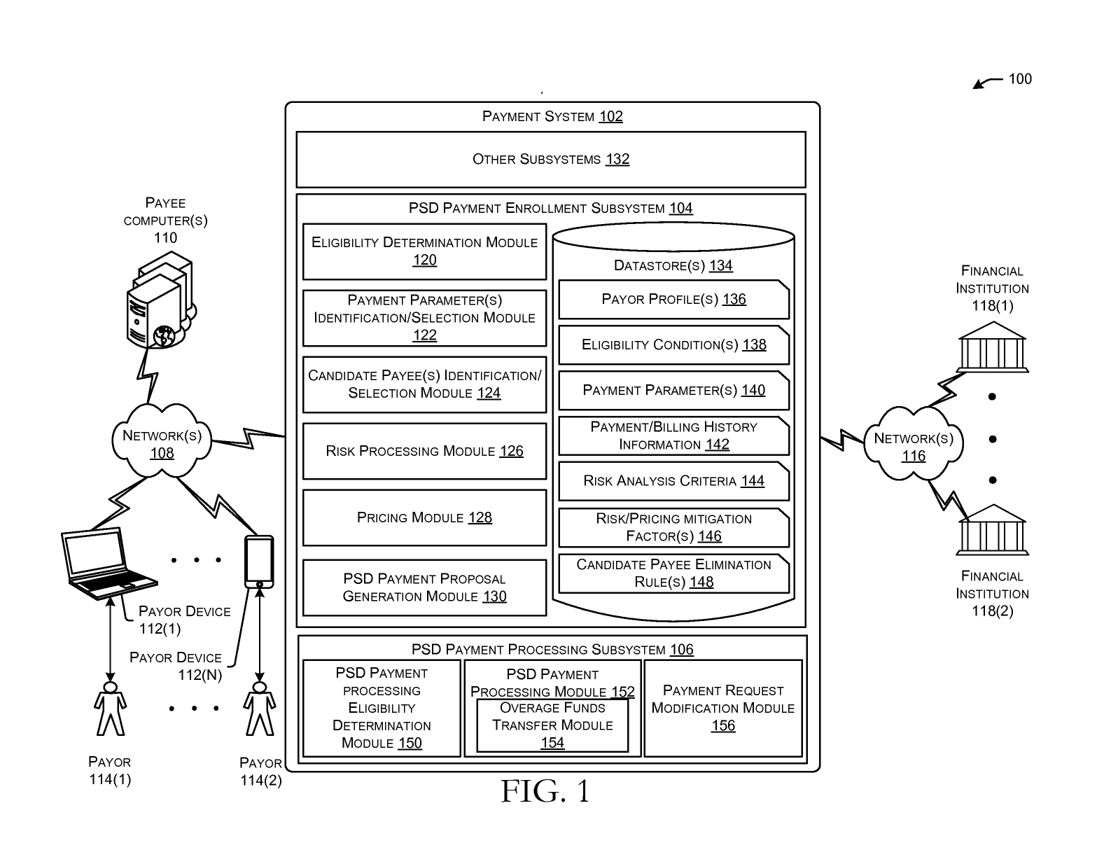

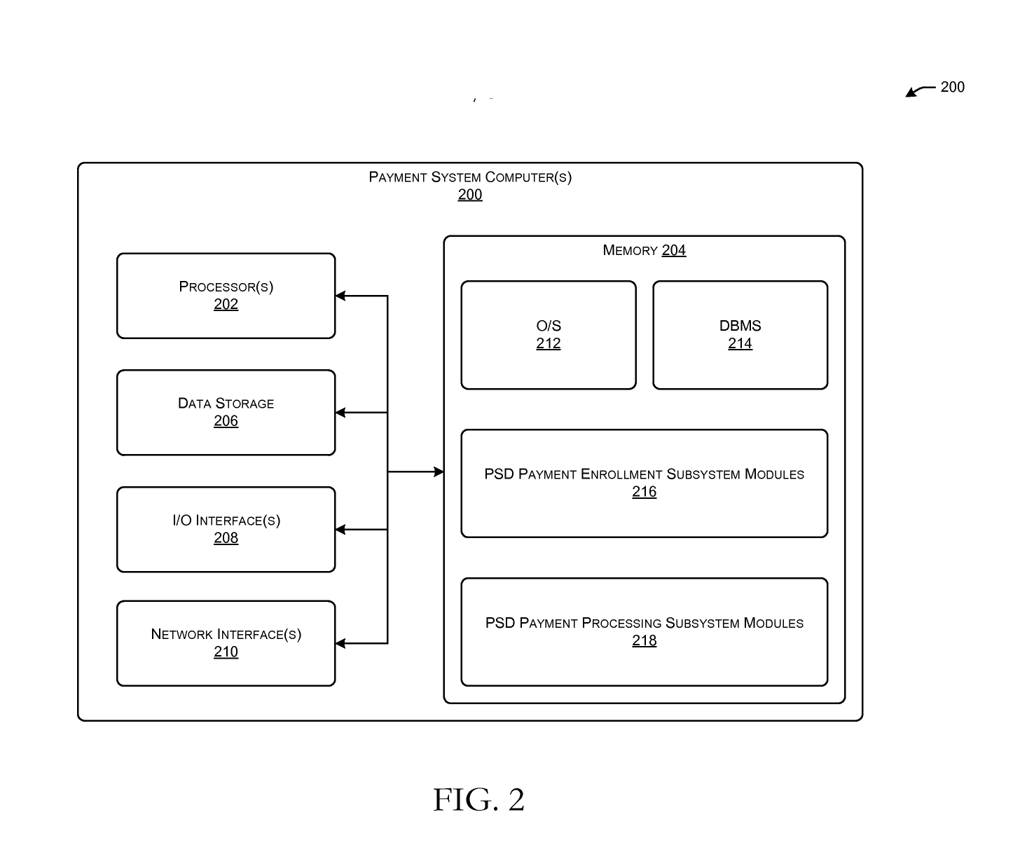

FIG. 1 is a schematic block diagram of an illustrative system architecture 100 that facilitates enrollment of a payor for PSD payment processing as well as processing of a payment request associated with a payor enrolled for PSD payment processing in accordance with one or more embodiments of the disclosure. FIG. 2 is a more detailed schematic block diagram illustrating various hardware and software sub-components of various components of the illustrative architecture of FIG. 1 in accordance with one or more embodiments of the disclosure. FIGS. 1 and 2 will be described hereinafter in conjunction with one another.

Referring to FIG. 1, the architecture 100 includes a payment system 102 that includes various subsystems including a PSD payment enrollment subsystem 104 that may support functionality associated with enrollment of a payor for PSD payment processing (e.g., generation of a PSD payment schedule for the payor). The payment system 102 may further include a PSD payment processing subsystem 106 that may support functionality for determining whether received payment requests satisfy various payment parameters associated with a PSD payment schedule established for a payor and either performing PSD payment processing in accordance with the established PSD payment schedule if the payment parameters are determined to be satisfied, or providing one or more alternative options to the payor for processing the payment request. The payment system 102 may further include one or more other subsystems 132 capable of supporting a wide range of other types of functionality such as various aspects of EBPP functionality.

Referring now to FIGS. 1 and 2, the payment system 102 may include one or more payment computers 200. In certain embodiments, each of the PSD payment enrollment subsystem 104 and the PSD payment processing subsystem 106 may include one or more respective payment system computers 200. The various respective program modules depicted as forming part of each subsystem 104, 106 may be executable on respective payment system computer(s) 200 of each subsystem. In certain embodiments, respective functionality supported by one or more program modules may be distributed across multiple payment system computers 200. Further, in certain embodiments, the subsystems 104, 106 may comprise one or more shared payment system computers 200 capable of supporting at least a portion of the respective functionality supported by one or more program modules of each subsystem 104, 106.

The payment system 102 may be configured to communicate with one or more payor devices 112(1)-112(N) (which may be referred to herein generically as payor device 112) over one or more networks 108. The payor device(s) 112 may be operable by one or more payors 114(1)-114(N) (which may be referred to herein generically as payor 114 or payor(s) 114). The payor device(s) 112 may include any suitable processor-driven device including, but not limited to, a desktop computer, a laptop computer, a workstation, a mobile device such as a smartphone or tablet device, and so forth. The payment system 102 may be further configured to communicate via one or more of the network(s) 108 with one or more payee computers 110 associated with one or more payees optionally including any one or more electronic billing payees, non-electronic-billing payees, non-billing payees, and so forth. The payee computer(s) 110 may include any suitable processor-driven device.

The functionality described herein as being supported by the payment system 102 may include user interface functionality that may be utilized by a payor to establish a PSD payment schedule or modify an existing PSD payment schedule as well as to initiate payment requests. For example, one or more user interfaces hosted by the payment system 102 or one or more customer service provider systems (not shown) operating as intermediate system(s) between the payment system 102 and payor device(s) 112 may be transmitted to the payor device(s) 112 for rendering on the payor device(s) by one or more client applications executable on the payor device(s) 112.

The client application(s) may include a thin-client application (e.g., a browser application (mobile or traditional)) that is capable of requesting and receiving content (e.g., user interface content) from a server device (e.g., a Web server) and rendering the content on a payor device 112 for presentation to a payor 114. The server device may be a payment system computer 200 or a server device associated with a customer service provider system. In the case of a thin-client application, the bulk of the processing and non-transient storage of data supporting the various user interfaces may occur at the server device. In other embodiments, the client application(s) may include a fat-client application such as a mobile application. In such a scenario, at least a portion of the processing described herein and/or at least a portion of the non-transient data storage may occur at the payor device 112.

The network(s) 108 may include any one or a combination of different types of suitable communications networks including, but not limited to, public networks (e.g., the Internet), private networks, wireless networks, cellular networks, cable networks, or any other suitable private and/or public networks. Further, the network(s) 108 may have any suitable communication range associated therewith and may include, for example, global networks (e.g., the Internet), metropolitan area networks (MANs), wide area networks (WANs), local area networks (LANs), or personal area networks (PANs). In addition, the network(s) 108 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

In addition, the payment system 102 may be configured to communicate with one or more financial institutions 118(1)-118(R) (or more specifically one or more financial institution systems, which may be referred to herein generically as financial institution system 118) via one or more payment networks 116. For example, the payment system 102 may generate and transmit, to one or more financial institution systems 118, debit and/or credit instructions for posting associated debits and/or credits, respectively, to financial accounts held at financial institutions. The payment network(s) 116 may include any suitable network including but not limited to, a debit network, a credit network, an Automated Clearinghouse (ACH) network, a proprietary network of financial institutions, and so forth.

Still referring to FIGS. 1 and 2, an illustrative payment system computer 200 may include one or more memories 204 (generically referred to herein as memory 204) and one or more processors (processor(s)) 202 configured to execute computer-executable instructions that may be stored in the memory 204. The payment system computer 200 may be any suitable processor-driven computing device including, but not limited to, a server computer, a mainframe computer, and so forth. While the payment system computer 200 is described as an illustrative component of the payment system 102, it should be appreciated that the payment system may potentially encompass additional software, firmware, and/or hardware components.

The processor(s) 202 may include any suitable processing unit capable of accepting digital data as input, processing the input data in accordance with stored computer-executable instructions, and generating output data. The processor(s) 202 may be configured to execute the computer-executable instructions to cause or facilitate the performance of various operations. The processor(s) 202 may be further configured to utilize various hardware resources available on the payment system computer 200 or the payment system 102 generally, to drive various peripheral devices, facilitate storage of data, and so forth. The processor(s) 202 may include any type of suitable processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a Field-Programmable Gate Array (FPGA), a System-on-a-Chip (SoC), and so forth.

The memory 204 may store computer-executable instructions that are loadable and executable by the processor(s) 202 as well as data manipulated and/or generated by the processor(s) 202 during the execution of the computer-executable instructions. The memory 204 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 204 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The payment system computer 200 may further include additional data storage 206 such as removable storage and/or non-removable storage including, but not limited to, magnetic storage, optical disk storage, and/or tape storage. Data storage 206 may provide storage of computer-executable instructions and other data. The data storage 206 may include storage that is internal and/or external to the payment system computer 200. The memory 204 and/or the data storage 206, removable and/or non-removable, are examples of computer-readable storage media (CRSM).

The memory 204 may store data, computer-executable instructions, applications, and/or various program modules including, for example, one or more operating systems 212 (generically referred to herein as operating system 212), one or more database management systems (generically referred to herein as DBMS 214), and one or more program modules such as program modules 216 forming part of the PSD payment enrollment subsystem 104 and program modules 218 forming part of the PSD payment processing subsystem 106.

The operating system (O/S) 212 may provide an interface between other applications and/or program modules executable by the payment system computer 200 (e.g., any of the various program modules of the subsystem 104 and/or the subsystem 106) and hardware resources of the payment system computer 200. More specifically, the O/S 212 may include a set of computer-executable instructions for managing hardware resources of the payment system computer 200 and for providing common services to other applications and/or program modules (e.g., managing memory allocation among various applications and/or program modules). The O/S 212 may include any operating system now known or which may be developed in the future including, but not limited to, any desktop or laptop operating system, any server operating system, any mobile operating system, any mainframe operating system, or any other proprietary or non-proprietary operating system.

The DBMS 214 may support functionality for accessing, retrieving, storing, and/or manipulating data stored in one or more datastores 134 provided externally to the payment system computer 200 and/or one or more internal datastores provided, for example, as part of the data storage 206. The DBMS 214 may use any of a variety of database models (e.g., relational model, object model, etc.) and may support any of a variety of query languages.

Illustrative types of data that may be stored in datastore(s) 134 are depicted in FIG. 1. The illustrative types of data may include, but are not limited to, one or more payor profiles 136 associated with one or more payors. The payor profile(s) may include data relating to PSD payment schedules that have been established for various payor(s) and associated payment parameters. The data stored in the datastore(s) 134 may further include various eligibility determination condition(s) 138 that a payor may be required to satisfy in order to be eligible for PSD payment processing, various payment parameter(s) 140 that may be selectable by a payor for association with a PSD payment schedule and/or specific values for such parameters that may be associated with specific payors, payment/billing history information 142 associated with one or more payors, risk analysis factor(s) 144 that may be assessed to determine a risk presented by various potential PSD payment schedules and associated payment parameter(s), pricing factor(s) 146 that may be assessed to appropriately price various PSD payment schedules (in certain embodiments the risk analysis factor(s) 144 and the pricing factor(s) 146 may overlap at least in part), and various candidate payee rule(s) that may be assessed to determine whether any particular payee is a candidate for payment in accordance with a PSD payment schedule.

While various illustrative types of data are depicted in FIG. 1 as being stored in the datastore(s) 134, it should be appreciated that at least a portion of the data may be stored in datastore(s) associated with a different subsystem (e.g., one or more of the other subsystems 132) and retrieved therefrom by the PSD payment enrollment subsystem 104 and/or the PSD payment processing subsystem 106. In other embodiments, the datastore(s) 134 may represent one or more datastores provided at least partially within the subsystem 104, one or more datastores provided at least partially within the datastores 106, and/or one or more datastores provided at least partially external to both subsystems 104, 106 but internal to the payment system 102. In yet other embodiments, one or more common datastores may be provided that are accessible by all subsystems of the payment system 102 and each of one or more subsystems of the payment system 102 may include a respective one or more local datastores for storing data that may be frequently accessed as part of functionality supported by the subsystem. It should be appreciated that various additional types of data beyond that depicted in FIG. 1 may be stored in one or more of the datastore(s) 134 and/or in one or more other datastores. Such data may include, but is not limited to, payee lists, managed payee/electronic biller information, invoice information, and so forth. Further, in certain embodiments, rather than storing a PSD payment schedule that identifies each payee to be paid in accordance with the PSD payment schedule, payment dates for crediting payment amounts to the payees, a debit date for debiting funds from one or more financial accounts of the payor, and so forth, portions of such information may be stored in association with respective payees as part of, for example, a payee profile or the like. For example, for each payee that is to be paid in accordance with PSD payment processing, respective information identifying the payor-specified debit date, funding accounts, pricing information, and so forth may be stored in association with each such payee.

The various types of data that may be stored in the datastore(s) 134 and the manner in which processing described herein may utilize the data will be described in more detail hereinafter. It should be appreciated that while the illustrative data described above is depicted in FIG. 1 as being stored in the datastore(s) 134, at least a portion of the data may be additionally, or alternatively, stored in the data storage 206 and/or the transient memory 204 of one or more payment system computers 200. Further, although not depicted in FIGS. 1 and 2, it should be appreciated that the memory 204, the data storage 206, and/or the datastore(s) 134 may store any number of additional applications, program modules, and/or data.

The payment system computer 200 may further include one or more I/O interfaces 208 that may facilitate receipt, by the payment system computer 200, of information input via one or more I/O devices configured to communicate with the payment system computer 200 as well as the outputting of information from the payment system computer 200 to the one or more I/O devices. The I/O devices may include, but are not limited to, a display, a keypad, a keyboard, a pointing device, a control panel, a touch screen display, a remote control device, a speaker, a microphone, a printing device, other peripheral devices, and so forth.

The payment system computer 200 may further include one or more network interfaces 210 that may facilitate communication between the payment system computer 200 and other components of the networked architecture 100 via one or more of the network(s) 108 and/or one or more of the network(s) 116. For example, the network interface(s) 210 may facilitate interaction between the payment system computer 200 and the payee computer(s) 110, the payor device(s) 112, the financial institution system(s) 118, one or more customer service provider systems (not shown), and so forth.

As previously described, various program modules may be executable on payment system computer(s) 200 forming part of each subsystem 104, 106. For example, various PSD payment enrollment subsystem modules 216 may be provided that may include an eligibility determination module 120, a payment parameter(s) identification/selection module 122, a candidate payee(s) identification/selection module 124, a risk processing module 126, a pricing module 128, and a PSD payment schedule proposal generation module 130. Further, one or more additional modules capable of supporting any of a variety of additional electronic bill presentment and/or bill payment functionality may be provided as part of the subsystem 104 and/or one or more other subsystem(s) 132 as well.

In addition, as previously described, various PSD payment processing subsystem modules 218 may be executable on payment system computer(s) 200 forming part of the PSD payment processing subsystem 106 and may include, for example, a PSD payment processing eligibility determination module 150, a PSD payment processing module 154, an overage funds transfer module 156 (which may be included as a sub-module of the PSD payment processing module 154 in certain embodiments), and a payment request modification module 156.

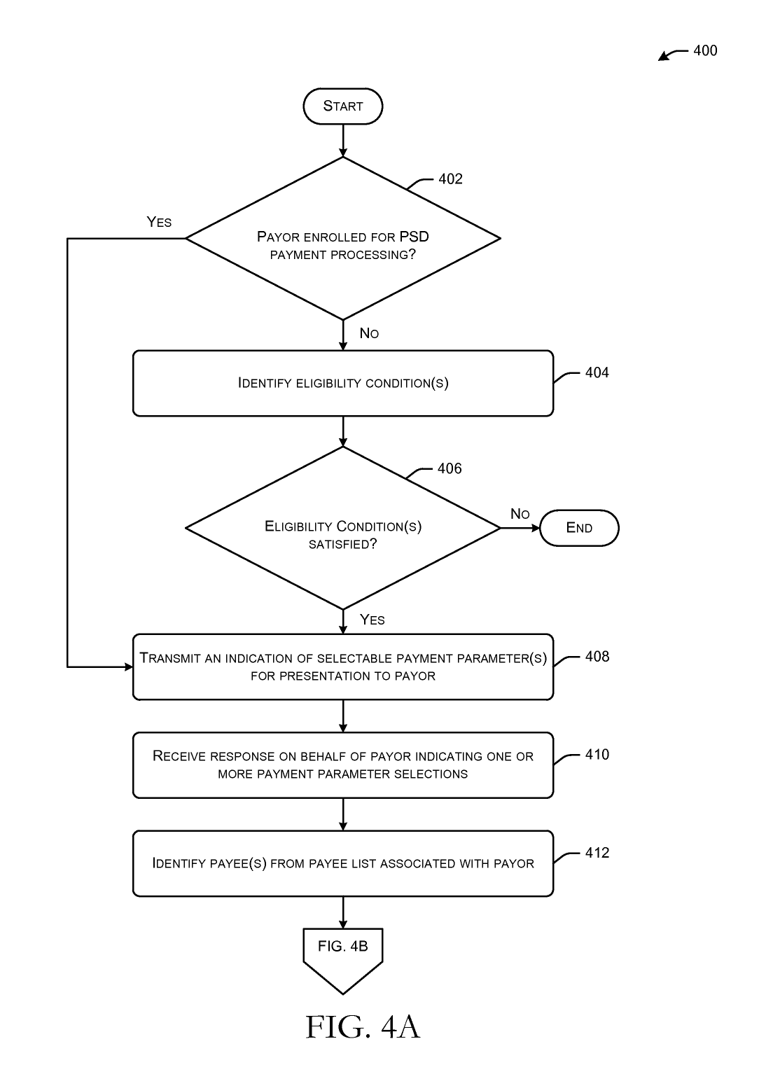

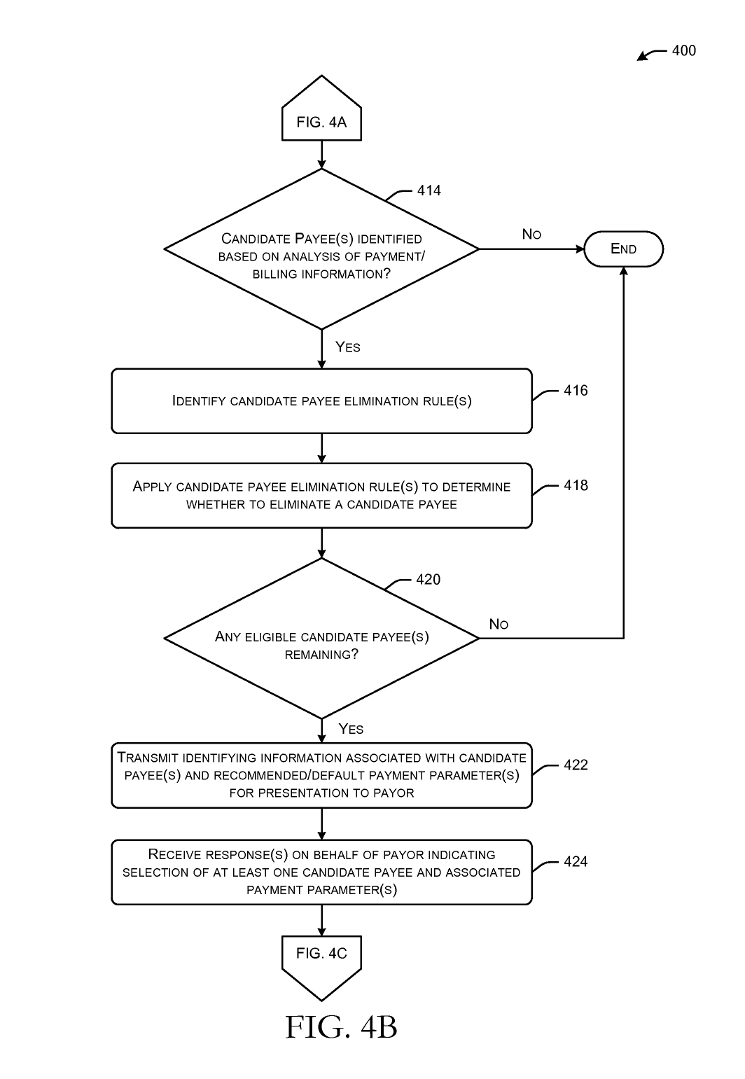

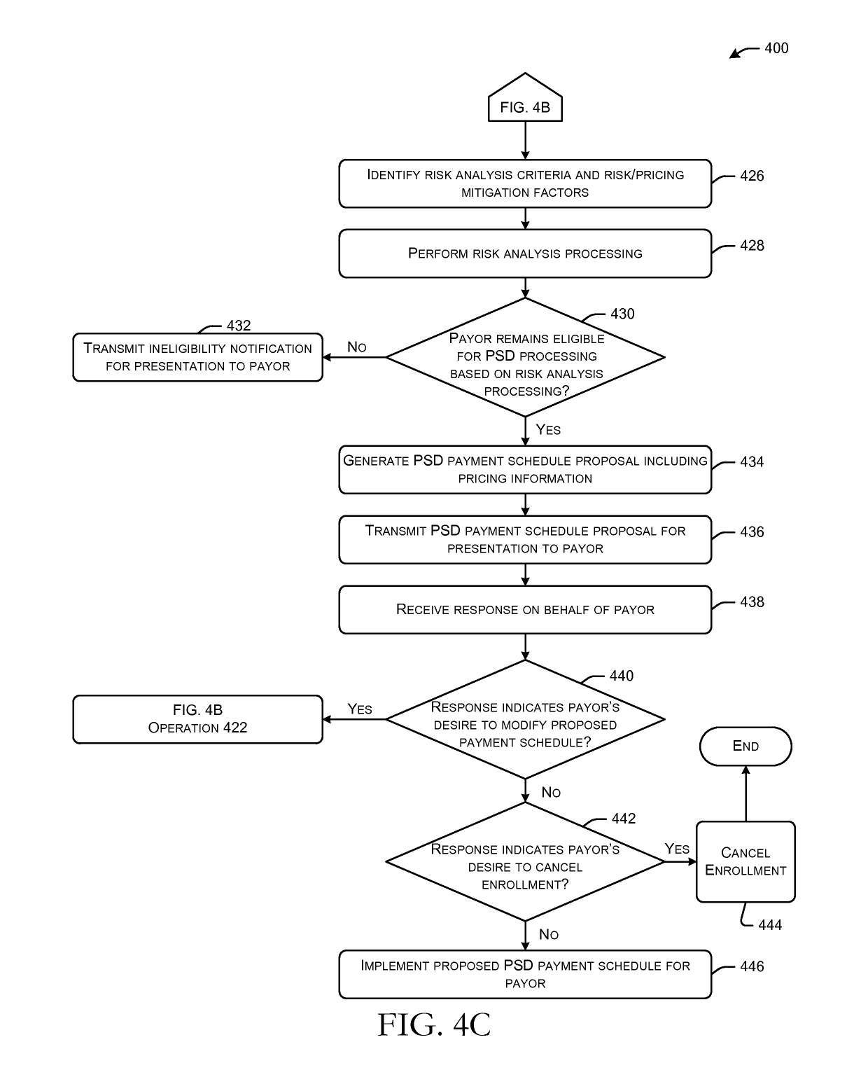

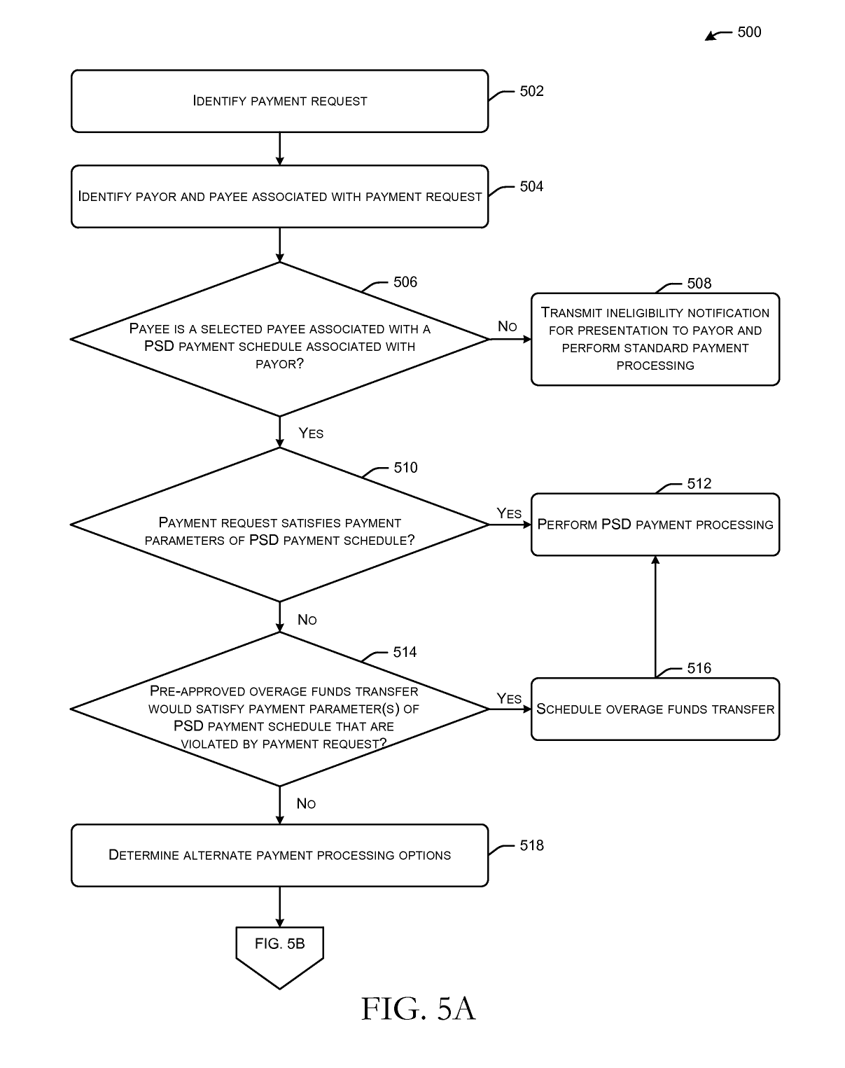

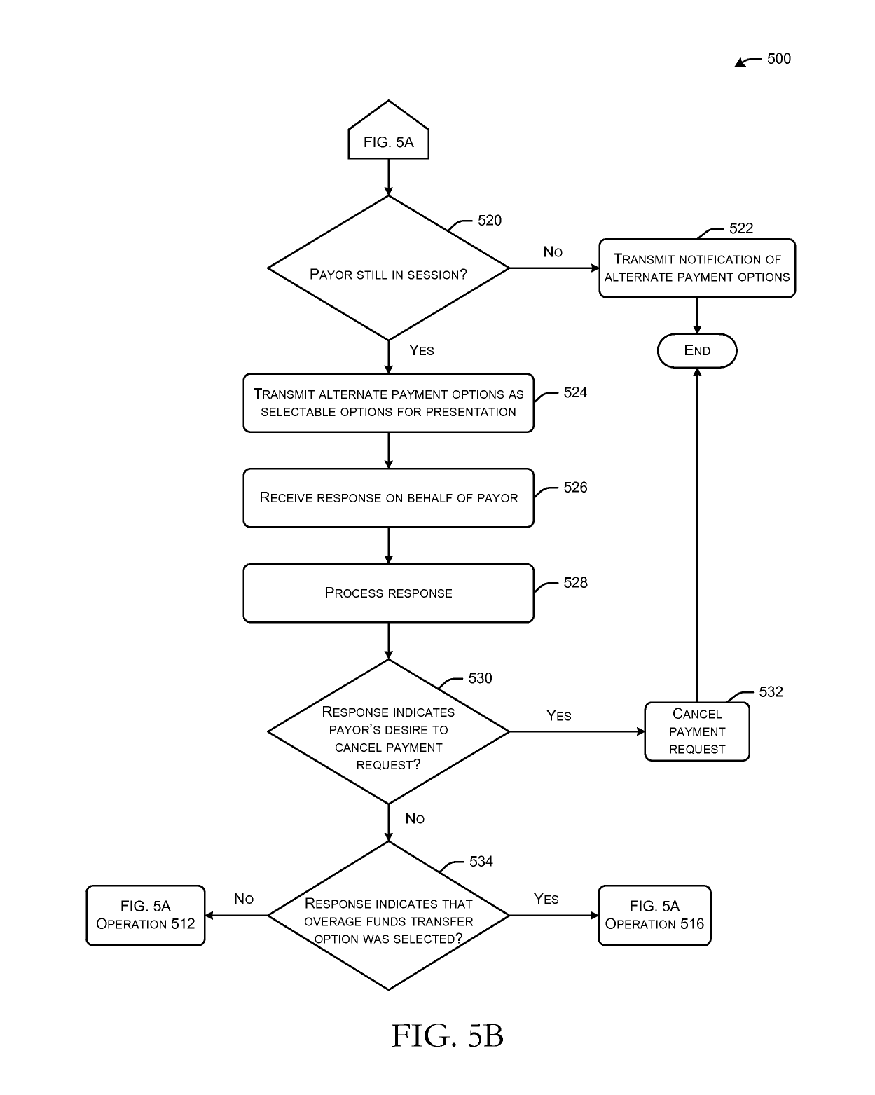

In various embodiments, the various PSD payment enrollment subsystem modules 216 may support respective functionality associated with various aspects of the processing for establishing a PSD payment schedule for a payor. Further, in various embodiments, the various PSD payment processing subsystem modules 218 may support respective functionality associated with various aspects of the processing of a payment request. Such processing will be described in greater detail through reference to the process flow diagrams of FIGS. 4A-5B.

It should be appreciated that the program modules described above are merely illustrative and that a fewer number, a greater number, or different program modules capable of supporting the same, similar, or different functionality may be provided. Further, the subsystems 104, 106 described above are merely illustrative and additional subsystems capable of supporting at least a portion of the functionality described above or additional functionality may be provided as part of the payment system 102 in various embodiments. In addition, in certain embodiments, functionality supported by any of the program modules of the payment system 102 may be distributed among multiple payment system computers 200 and multiple subsystems (e.g., subsystems 104 and 106) of the payment system 102 may include one or more shared payment system computers 200 configured to support at least a portion of the respective functionality supported by each of the subsystems 104, 106 (or more specifically respective program module(s) of each of the subsystems).

It should be further appreciated that while one or more components of the illustrative architecture 100 may be described in the singular, a plural number of any such component(s) (potentially forming part of a system that includes additional hardware, software, firmware, and/or networking components) is also encompassed by this disclosure. Further, in various embodiments, a singular number of any components described using plural terminology may be provided.

While not depicted in FIG. 2, the payor device(s) 112, the payee computer(s) 110, and/or the financial institution system(s) 118 may include one or more of the hardware and software components illustratively depicted in connection with the payment system 102 and/or the payment system computer 200 and/or different hardware or software component(s).

Those of ordinary skill in the art will appreciate that the illustrative networked architecture 100 depicted in FIG. 1 and the illustrative device depicted in FIG. 2 is provided by way of example only. Numerous other operating environments, system architectures, and device configurations are within the scope of this disclosure. Various embodiments of the disclosure may include fewer or greater numbers of components and/or devices than those depicted in FIGS. 1 and 2, which may incorporate some or all of the functionality described with respect to the illustrative architecture 100 depicted in FIG. 1, or additional functionality.

Those of ordinary skill in the art will appreciate that any of the components of the architecture 100 may include alternate and/or additional hardware, software or firmware components beyond those described or depicted without departing from the scope of the disclosure. More particularly, it should be appreciated that software, firmware or hardware components depicted as forming part of any of the components of the architecture 100 are merely illustrative and that some components may not be present or additional components may be provided in various embodiments. While various program modules have been depicted and described with respect to various illustrative components of the architecture 100, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, firmware and/or hardware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules.

### Illustrative Processes

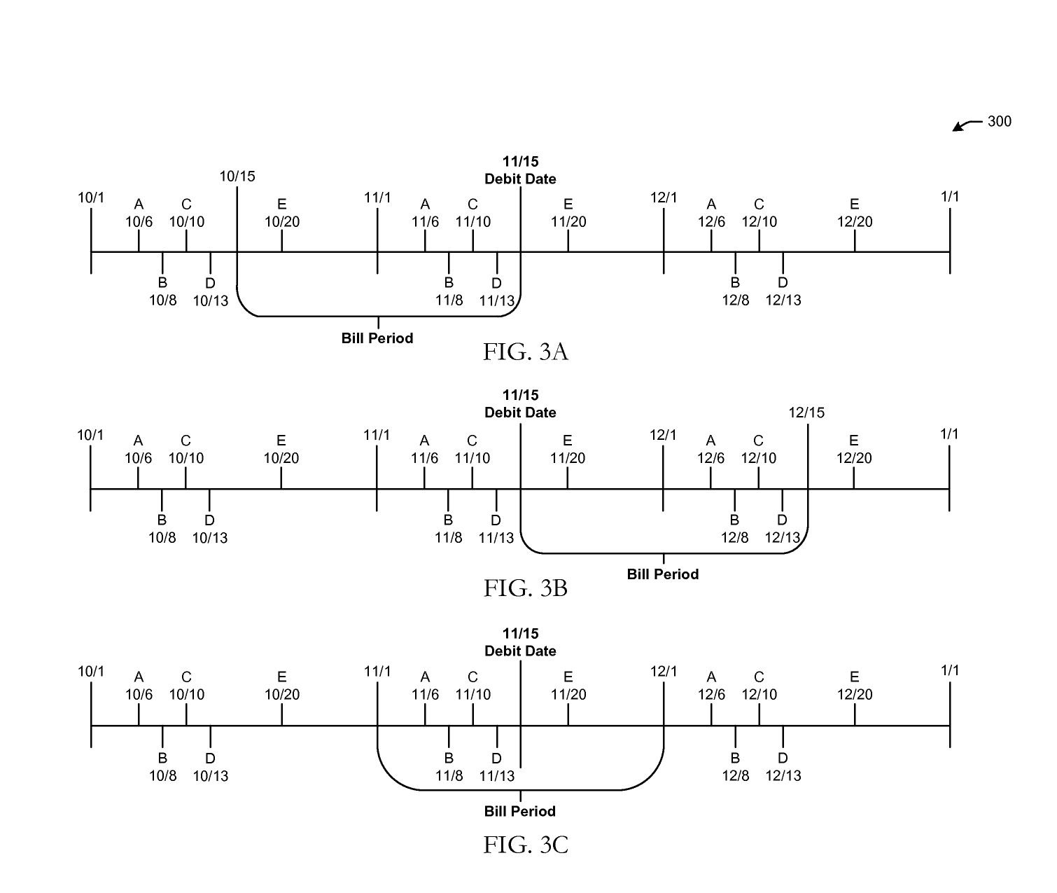

FIGS. 3A-3C depict various illustrative payor-scheduled-debit bill payment schedules in which a billing period associated with one or more payees predates, follows, or straddles a debit date in accordance with one or more embodiments of the disclosure. The dates depicted in each of FIGS. 3A-3C may represent dates (some of which may be approximate dates) on which payments from a payor may be credited to financial accounts associated with various payees. The payees may include any of variety of types of payees that may be paid in accordance with a regular payment cycle including, but not limited to, an electronic biller, a billing and/or non-billing payee associated with recurring payments, a billing and/or non-billing payee receiving periodic payments manually initiated by a payor in accordance with a regular payment cycle, a billing and/or non-billing payee receiving payments (e.g., “singleton” payments) in accordance with a regular payment cycle, and so forth.

In FIG. 3A, an illustrative scenario in which a payor selects a bill period that precedes a selected debit date is depicted. In such a scenario, payees may be paid before payment amounts are debited from one or more financial accounts associated with the payor. A variety of risk analysis processing and pricing determinations may be made under such a scenario.

In FIG. 3B, another illustrative scenario is depicted in which a bill period selected by the payor is subsequent to the selected debit date. In such a scenario, payment amounts associated with payments made to payees may be debited from financial account(s) held by the payor on a debit date that is prior to dates on which the payment amounts are credited to respective payees. In such a scenario, minimal, if any, risk analysis processing may be performed (other than potentially standard risk analysis associated with payment processing) and the pricing of the PSD payment schedule under this scenario may be correspondingly lower than the pricing associated with the scenario in which the bill period precedes the debit date.

FIG. 3C depicts yet another illustrative scenario in which a bill period selected by a payor may include a first portion that precedes the debit date and a second portion that follows the debit date. Under such a scenario, certain payees may be credited prior to the debit date while certain other payees may be credited subsequent to the debit date. Accordingly, such a scenario may encompass aspects of both of the other scenarios depicted respectively in FIGS. 3A and 3B. For those payees that are to be credited prior to the debit date, the more involved risk analysis processing described above in connection with the scenario depicted in FIG. 3A may be performed and the pricing may be correspondingly higher. For those payees that are to be credited subsequent to the debit date, the standard risk processing described above in connection with the scenario depicted in FIG. 3B may be performed (or not performed at all) and the pricing may be correspondingly lower. In certain embodiments, pricing associated with the scenario depicted in FIG. 3C may be intermediate to pricing associated with the scenarios depicted in FIGS. 3A and 3B.

FIGS. 4A-4C are process flow diagrams of illustrative processing 400 for determining eligibility of a payor for PSD payment processing and generating a PSD payment schedule for association with the payor in accordance with one or more embodiments of the disclosure. One or more operations of the illustrative processing 400 may be performed upon execution of computer-executable instructions provided as part of one or more program modules of the PSD payment enrollment subsystem 104. Processing that is performed upon execution of computer-executable instructions of a program module may be described herein as being performed by the program module itself. Further, one or more operations of the illustrative processing 400 may be described with reference to the example system architecture 100 depicted in FIG. 1.

At block 402, the eligibility determination module 120 may make a determination as to whether a payor is currently enrolled for PSD payment processing. The payor may be a payor 114 that initiates communication with the payment system 102 using an associated payor device 112. For example, one or more user interfaces hosted by the payment system 102 (or one or more intermediate systems) and which enable interaction between the payor and the payment system 102 may be rendered on the payor device 112 for presentation to the payor 114.

The determination at block 402 may involve a determination as to whether a PSD payment schedule is already associated with the payor. In certain embodiments, if the payor was previously determined to be eligible for PSD payment processing, a determination may be made that the payor remains eligible. A payor profile 136 associated with the payor may be accessed to determine whether the payor was previously determined to be eligible for PSD payment processing and/or whether an existing PSD payment schedule is associated with the payor.

In certain embodiments, the payor may have discontinued a previous PSD payment schedule, in which case, various settings (e.g., payment parameters) associated with the previous PSD payment schedule may be reset. Further, in certain embodiments, an administrator may discontinue a previous PSD payment schedule based on failure of the payor to comply with the PSD payment schedule. In certain embodiments, even if a PSD payment schedule is discontinued, an indication that the payor was once associated with a PSD payment schedule may be stored in the payor profile and a determination that the payor remains eligible for PSD payment processing may be made based on such an indication, except perhaps in those embodiments in which an administrator discontinued the previous PSD payment schedule.

If it is determined at block 402 that the payor is already associated with an existing PSD payment schedule, or in certain embodiments, that the payor discontinued a previous PSD payment schedule of his/her own accord, the processing 400 may proceed to block 408. On the other hand, if it is determined at block 402 that the payor is not currently enrolled in PSD payment processing (e.g., the payor is not associated with an existing PSD payment schedule), the processing may proceed to block 404.

At block 404, the eligibility determination module 120 may identify one or more eligibility conditions 138 for assessing an eligibility of the payor for establishment of a PSD payment schedule. The eligibility condition(s) 138 may be established by a service provider (e.g., an EBPP service provider) associated with the payment system 102 or another entity that controls the risk processing and/or pricing determination processing associated with enrollment for PSD payment processing.

The eligibility condition(s) 138 may include one or more of the following: i) a condition that ensures that the payor is not too recent of an enrollee for services provided by the payment system 102 such as, for example, a minimum number of months that the payor has been enrolled with an electronic bill presentment and/or electronic bill payment service hosted by the payment system 102; ii) a minimum number of successful posted payments made by the payor; iii) a threshold number of payment-related issues associated with payments made by the payor (e.g., payments being declined for insufficient funds, payment posting failures, etc.), potentially over the span of a specified number of months; iv) whether online banking or core account information associated with the payor is available such as information identifying current available balances in one or more financial accounts associated with the payor, information identifying deposit patterns associated with the payor, information identifying transactional activity/patterns associated with the payor, and so forth; v) the availability of funds in one or more financial accounts associated with the payor in order to support potential overdraft situations; vi) any financial institution sponsor constraints prohibiting PSD payment processing functionality from being offered to the payor; vii) one or more metrics indicative of an acceptable current or past use of PSD payment processing functionality (e.g., fewer than a threshold number of issues within a specified period of time), and so forth. It should be appreciated that the above examples of eligibility conditions 138 are merely illustrative and not exhaustive and that numerous other conditions may be assessed.

Upon identification of the eligibility condition(s) 138, the eligibility determination module 120 may access the condition(s) with respect to available information associated with the payor to determine whether the condition(s) are satisfied. If it is determined at block 406 that at least one eligibility condition is not satisfied (or that some threshold number of eligibility conditions are not satisfied), the payor may be determined not be eligible for PSD payment processing, and the enrollment processing 400 may end. On the other hand, if it is determined that all eligibility condition(s) are met (or that some threshold number of conditions are met), the enrollment processing may proceed to block 408.

At block 408, computer-executable instructions provided as part of the payment parameter(s) identification/selection module 122 may be executed to identify various selectable payment parameters 140 and to transmit the identified parameters 140 to the payor device for presentation to the payor. In certain embodiments, the payor may be prompted to associate values with each of the payment parameters. Further, in various embodiments, one or more predefined selectable options may be transmitted for presentation to the payor in association with one or more selectable payment parameters. In the event that a previous PSD payment schedule is associated with the payor, pre-existing values associated with payment parameters may be transmitted for presentation to the payor. The payor may be afforded the opportunity to modify any such pre-existing payment parameter values. In addition, in those embodiments in which the payor is permitted to establish multiple PSD payment schedules, the presentation may query the payor as to whether the payor wishes to establish a new schedule or modify an existing one.

In certain embodiments, the payor may be required to associate values with only certain payment parameter(s). For example, in various embodiments, the payor may be required to specify a debit date payment parameter (e.g., a particular date each month to debit payment amounts from one or more financial accounts associated with the payor). As previously described, the payor may be able to specify alternate debit patterns in lieu of a specific debit date.

The payor may be further required to associate values with other payment parameters. For example, the payor may be required to specify a start day for a billing period to associate with the PSD payment schedule (e.g., a particular date in the current or previous month). In certain embodiments, a default billing period that begins a day after the debit date of the previous month may be associated with the PSD payment schedule. The payor may be further required to specify a duration of the billing period. A default duration of one month from the start day may be associated with the PSD payment schedule. The payor may be further required to specify one or more funding accounts to use in overdraft situations. The funding account(s) may include account(s) held at different financial institution(s) if inter-bank funds transfer capability and/or access to a credit or debit payment network is provided. The funding account(s) may include, but are not limited to, i) a demand deposit account (DDA) such as a checking account, a money market account, a line of credit, potentially a savings account, or the like, ii) a debit card account; iii) a credit card account; iv) or another type of account that can be accessed in a similar manner.

At block 410, the payment parameter(s) identification/selection module 122 may receive a response from the payor device on behalf of the payor that indicates a the payor's desire to establish a PSD payment schedule or modify an existing one and that includes an indication of one or more payment parameter selections such as a debit date. Additional payment parameter selections may be received as well.

At block 412, computer-executable instructions provided as part of the candidate payee(s) identification/selection module 124 may be executed to identify one or more payees associated with the payor and payment/billing history information 142 associated with the identified payee(s) and the payor.

Referring now to FIG. 4B, computer-executable instructions provided as part of the candidate payee(s) identification/selection module 124 may be executed to determine whether any of the identified payee(s) are potential candidate payee(s) based on an analysis of the payment/billing history information 142. As previously discussed, payee(s) that receive payments from the payor on an approximately regular schedule may be identified as potential candidate payees. In certain embodiments, payee(s) identified as potential candidate payees may be those that receive payments within the billing period selected by the payor.

Payee(s) identified as potential candidate payees may include: i) a payee that receives payments from the payor based on a recurring payment model associated with a monthly payment cycle (or a payment cycle of greater or lesser frequency), ii) a payee for whom electronic billing has been activated in accordance with a monthly billing cycle (or a billing cycle of greater or lesser frequency), iii) a payee associated with a threshold number of months of prior payment history, or the like. In certain embodiments, in order to identify a payee as a potential candidate payee, the prior payment history may need to indicate one or more of the following: i) that the payor made at least one payment to the payee per month, ii) that the payment dates associated with payments that were made fall within a certain threshold or tolerance deviation from a particular date each month, iii) that a difference between each of the payment amounts and a fixed amount is within a certain threshold or tolerance level.

If it is determined at block 414 that none of the identified payee(s) are potential candidate payees based on an analysis of the payment/billing history information 142, the enrollment processing may end. On the other hand, if it is determined that at least one potential candidate payee exists, the processing 400 may proceed to block 416 where the candidate payee(s) identification/selection module 124 may identify one or more candidate payee elimination rules 148. The candidate payee elimination rule(s) 148 may be associated with an entity hosting the payment system 102 (e.g., an EBPP service provider such as a third party service provider or a financial institution) or with an entity that performs risk processing.

In certain embodiments, the candidate payee elimination rule(s) may specify various characteristics associated with the payor and/or a payee that if satisfied would result in elimination of a payee as a candidate payee. For example, in certain embodiments, a payee may be eliminated as a candidate payee if any one or more of the following conditions are met: i) the payee corresponds to the payor, ii) the payee is associated with a same address as the payor, iii) the payee has a same last name as the payor, iv) the payee is a non-electronic payee, v) the payee is a non-reversible payee, vi) the payee is associated with a certain category (e.g., industry code), or conversely, a payee is not classified in accordance with at least one of a set of acceptable categories or industry codes, vii) the payee fails to meet some other service provider relationship/history condition. It should be appreciated that the above examples of candidate payee rules are merely illustrative and not exhaustive.

At block 418, the candidate payee elimination rule(s) 148 may be applied to eliminate any potential candidate payee(s) that were determined to exist at block 414 based on an analysis of payment/billing information. A determination may then be made at block 420 as to whether any candidate payee(s) remain after application of the elimination rule(s) 148 at block 418. If it is determined that no candidate payee(s) remain, the enrollment processing may end.

On the other hand, if it is determined that at least one candidate payee remains, the processing 400 may proceed to block 422 where information associated with each such candidate payee may be identified/determined and transmitted to the payor device for presentation to the payor. The identified information may include recommended or default payment parameters for association with the payee as part of the PSD payment schedule. For example, the information may include, for each candidate payee, one or more of the following: i) an identifier associated with the candidate payee that is recognizable by the payor (e.g., a name associated with the payee in a payee list); ii) a suggested amount for a monthly payment (e.g., a monthly payment upper limit identifying a maximum amount eligible for association with the payee as part of the PSD payment schedule); iii) a default date each month for payment to be made to the payee; and so forth. In certain embodiments, the suggested amount for the monthly payment to a payee may be based on one or more of: i) a mean of payment amounts for a previous predetermined number of months, or ii) the highest payment value for a previous predetermined period of months. The payment amount that is suggested may affect pricing for the PSD payment schedule. Further, the number of days of debit deferral as dictated by the debit date and the default date for payment may affect pricing as well.

The payor may be provided with various options upon receipt of the information associated with the candidate payee(s). For example, the payor may be provided with a capability to modify the payment amount (e.g., the monthly payment upper limit) associated with any payee, potentially within certain per-payee maximum constraints or aggregate maximum constraints across all candidate payees. In certain embodiments, if a payee is a non-activated electronic biller, an option to activate electronic bill presentment may be presented in association with the payee. In various embodiments, if the payor chooses to activate electronic bill presentment for one or more payees, such activation may have an influence on pricing.

Additional options may be presented to the payor at blocks 422 including one or more of the following: i) the opportunity to specify a funding account on a per payee basis, ii) the opportunity to split a payment on a per payee basis (e.g., a payment amount up to a payment amount limit is to be applied against a first funding account and a payment amount in excess of the limit (potentially up to a second limit) is to be applied against a second funding account, iii) the opportunity to modify the default payment date associated with the payee, or iv) the opportunity to pre-authorize transfers from another funding account or a charge to a credit or debit card account for any payment amount overages applicable to all candidate payees or specified on a per-payee basis. It should be noted that the option of modifying the default payment date associated with a payee may not be provided to the payor in certain scenarios such as, for example, if a recurring payment model or autopay schedule has been established with the payee and a change to the payment date may trigger a change in the recurring payment model or the autopay schedule. It should further be noted that the above examples of additional selectable options that may be presented to the payor are merely illustrative and not exhaustive.

At block 424, the candidate payee(s) identification/selection module 124 may receive a response message from the payor device indicating the payor's selection of at least one candidate payee and an associated payment amount. The response may further include an identification of additional payee/amount combinations as well as additional parameters (e.g., activation of bill presentment and associated required activation parameters). In certain embodiments, rather than receiving a single response, a set of responses may be received by the payment system 102. For example, a response indicating a desire to activate electronic bill presentment for one or more billers may be received independently of a response message indicating selection of candidate payee(s) and associated payment parameters. In such a scenario, electronic bill presentment activation may be performed separately.

Referring now to FIG. 4C, at block 426, various risk analysis data 144 and risk/pricing mitigating factors 146 may be identified. At block 428, computer-executable instructions provided as part of the risk processing module 126 may be executed to perform risk analysis processing based at least in part on the information included in the response received on behalf of the payor, identified risk analysis data 144, and/or the risk/pricing mitigating factors 146. The risk analysis and associated pricing determination may be based at least in part on the total value of payment amounts to be debited for each selected candidate payee as well as the total amount of days of debit deferral. In certain embodiments, the pricing determination for a PSD payment schedule may be correlated to a risk identified by the risk analysis processing. The risk analysis processing may include assessing risk with respect to risk analysis data relating to one or more obligations not selected for inclusion in the PSD payment schedule such as, for example, received bills, already scheduled payments, patterns determined from payment history, information obtained from online banking or core account information, and so forth. The risk analysis processing may further include assessing risk with respect to risk analysis data relating to the payor's prior billing and payment history behavior in order to assess the payor's credit-worthiness. If the risk analysis data includes online banking or core account data, the risk analysis processing may evaluate this data to identify deposit patterns (and amounts), transactional activity (and patterns), and/or ratio of debits to credits on an average monthly basis. Other external sources (e.g., a credit bureau) may be accessed to identify additional risk analysis data for use in assessing a credit-worthiness of the payor.

In accordance with one or more embodiments, certain factors may offset risk and/or reduce pricing. Such risk/pricing mitigating factors 146 may include one or more of the following: i) whether a payee is a reversible merchant (and if so, the merchant credit limit), ii) the nature of the payee (e.g., a category/industry code associated with the payee, iii) whether an overage transfer has been pre-authorized for all selected payees or on a per-payee basis as a function of split payments, iv) a type of account specified for overage transfer (e.g., a DDA vs. a credit or debit card account), v) whether the payor has activated the payee for electronic billing, vi) whether the payor has established a recurring payment model or autopay schedule for the payee, or vii) past payment behavior of the payor for a particular payee, for other electronic bills, for all payees or some subset thereof, etc. It should be appreciated that the above example of risk/pricing mitigating factors are merely illustrative and not exclusive.

At block 430, the risk processing module 126 may determine whether the payor remains eligible for PSD processing enrollment based at least in part on the results of the risk processing performed at block 428. If it is determined that the payor is no longer eligible, an ineligibility notification may be generated and transmitted to the payor device for presentation to the payor at block 432.

On the other hand, if the payor continues to remain eligible for PSD payment processing enrollment based on the results of the risk processing, the processing 400 may proceed to block 434, where computer-executable instructions provided as part of the PSD payment schedule proposal generation module 130 may be executed to generate a payment schedule proposal. Computer-executable instructions provided as part of the pricing module 128 may be executed to generate pricing information. The pricing indicated by the pricing information may be per transaction pricing or bundle pricing based on a set of transaction requests and associated analysis and factors.

The PSD payment schedule proposal generated at block 434 may be transmitted to the payor device at block 436 for presentation to the payor. The payor may be provided with the capability to: i) accept the proposal, ii) modify one or more characteristics associated with the PSD payment schedule proposal, or iii) cancel the pending enrollment for PSD processing.

In the context of acceptance, the payor may further be given the option of applying the proposed PSD payment schedule to pending payment requests for any of the selected payees. As a default condition, the PSD payment schedule may be applied only to new payment requests received or instantiated after enrollment of the payor is completed and the PSD payment schedule is implemented and associated with the payor (e.g., stored in association with the payor profile associated with the payor). In certain other embodiments, the PSD payment schedule may be applied to already pending payment requests. However, in certain circumstances, application to pending payment requests may introduce processing complexity and potentially inconsistent behavior. For example, the PSD payment schedule may only be applied retroactively to already pending requests if the selected debit date has not passed. Further, payment request processing that had been performed on the pending payment request (as will be described in more detail later in this disclosure) may need to be executed again in order to determine whether the payment processing may be automatically modified to accommodate processing in accordance with the PSD payment schedule or whether interaction with the payor may be needed such as, for example, to approve an increased fee and/or supply additional information such as a financial account from which overage amounts may be debited.

Upon transmission of the PSD payment schedule proposal at block 436, a response may be received by the payment system 102 on behalf of the payor at block 438. A determination may be made at block 440 as to whether the response indicates a payor's desire to modify the proposed PSD payment schedule. If it is determined that the response indicates a desire to modify the proposed PSD payment schedule, the processing may again proceed to block 422 where information associated with the eligible candidate payees and potentially including recommended/default payment parameters for association with the eligible candidate payees may again be transmitted for presentation to the payor.

On the other hand, if it is determined that the response does not indicate a payor's desire to modify the proposed PSD payment schedule, the processing 400 may proceed to block 442 where a determination may be made as to whether the response received on behalf of the payor indicates the a payor's desire to cancel the pending enrollment for PSD payment processing. If it is determined that the response indicates a payor's desire to cancel the enrollment, the payor's enrollment for PSD payment processing may be canceled at block 444.

On the other hand, if it is determined that the response does not indicate a desire to cancel enrollment, it may be determined by default that the response indicates an acceptance of the proposed PSD payment schedule. In other embodiments, a separate determination may be made as to whether the response indicates approval based, for example, on an explicit indication of approval included in the response. If it is determined that the response received on behalf of the payor indicates acceptance of the proposal by the payor, the proposed PSD payment schedule may be implemented at block 446 for the payor in accordance with the payor-specified payment parameters.

Implementation of the approved PSD payment schedule may include, but is not limited to, i) storing information (e.g., setting a flag) in the payor profile associated with the payor that indicates that the payor has been enrolled for PSD payment processing (e.g., that an active PSD payment schedule has been associated with the payor), and ii) setting various parameters for each payee associated with the PSD payment schedule (e.g., each payee associated with payments having a same debit date). More specifically, an identifier associated with the PSD payment schedule may be associated with each payee. Further, various payee-specific payment parameter values relating to the PSD payment schedule may be stored in association with the corresponding payee such as, for example, a payment amount limit, a default payment date each month, one or more funding accounts to be debited, one or more funding accounts to be debited for any overages over the specified payment limit, a potential second payment limit for an overage transfer, per-transaction pricing (e.g., an individual transaction fee associated with each debit), and so forth. It should be appreciated that the above examples of payee-specific payment parameters that may be set are merely illustrative and not exhaustive.

In addition, various payment parameters that may be applicable to all payees associated with the PSD payment schedule may be stored in association with information pertaining to the PSD payment schedule. Such payment parameters may include, for example, a selected debit date (or alternative debit pattern), an aggregate payment amount limit applicable to all payments to all payees, an aggregate number days of debit deferral associated with payments to all payees, a general financial account from which to debit any overages associated with payment amount limits associated with specific payees or an aggregate total payment amount limit applicable to the sum of all payments to all payees, bundle pricing (e.g., a single composite fee to be included in each debit regardless of the payee associated with the payment), and so forth. It should be appreciated that the above examples of payee-specific payment parameters that may be set are merely illustrative and not exhaustive.

FIGS. 5A-5B are process flow diagrams of illustrative payment request processing 500 in accordance with one or more embodiments of the disclosure. One or more operations of the illustrative processing 500 may be performed upon execution of computer-executable instructions provided as part of one or more program modules of the PSD payment processing subsystem 106 such as, for example, the PSD payment processing eligibility determination module 150, the PSD payment processing module 152, the overage funds transfer module 154, and/or the payment request modification module 156. Processing that is performed upon execution of computer-executable instructions of a program module may be described herein as being performed by the program module itself.

At block 502, payment request processing may be initiated upon identification of a payment request. In certain embodiments, the payment request may correspond to a new payment request received from a payor that is in session. The new payment request may be associated with a timeframe in which posting of the payment is requested (e.g., “immediate”, “as soon as possible”, “future-dated,” etc.). In other embodiments, the payment request may be selected from a stored payment request that is eligible for payment request processing. The stored payment request may be associated with prior receipt by the payment system 102 of a future-dated “singleton” payment request, instantiation of a payment request generated in accordance with a pre-established recurring payment model, or instantiation of a payment request in accordance with an “autopay” schedule in response to a newly received electronic bill.

Upon identification of the payment request, a payee and a payor associated with the payment request may be identified at block 504. Various determinations may then be performed as part of the payment request processing to determine whether i) the payment request is to be processed in accordance with standard payment processing, ii) the payment request can be automatically processed in accordance with a PSD payment schedule associated with the payor and the payee, or iii) due to an exception situation, interaction with the payor is required prior to being able to process the payment request in accordance with a PSD payment schedule. One or more of the above determinations may be made responsive to execution of computer-executable instructions provided as part of the payment processing eligibility determination module 150.

At block 506, a determination may be made as to whether the identified payee is a selected payee associated with a PSD payment schedule associated with the identified payor. The determination at block 506 may additionally be performed at a stage at which the payor identifies a payee via a user interface rendered on a payor device and prior to submission of the payment request via the user interface thereby affording the payor the opportunity to override PSD payment schedule processing for the submitted payment request and revert to standard payment processing. If it is determined that the payee is not a payee associated with a PSD payment schedule that is associated with the payor, at block 508 a notification that the payee is ineligible for PSD payment processing may be transmitted for presentation to the payor and standard payment processing may be performed on the payment request. In certain embodiments, while standard payment processing may be performed at block 508, a notification that the payee is ineligible for PSD payment processing may not be transmitted.

On the other hand, if it is determined that the payee is a payee associated with a PSD payment schedule associated with the payor, a second determination may be made at block 510 as to whether the payment request satisfies payment parameters (and optionally other processing rules) associated with the PSD payment schedule. Illustrative examples of the determinations that may be made at block 510 may include whether the payment request is a first payment request received on behalf of the payor for the payee within the billing period associated with the PSD payment schedule, whether the payment date associated with the payment request is the same date as the default payment monthly payment date associated with the payee (or within an acceptable threshold number of days from the default date), whether the payment amount exceeds a specific payment limit associated with the payee or an aggregate payment amount limit associated with all selected payees, and so forth.

If it is determined that the payment request satisfies applicable payment parameters associated with the PSD payment schedule, PSD payment processing may be performed on the payment request in accordance with the PSD payment schedule at block 512. It should be appreciated that, in various example embodiments, the payor may be provided with a capability to specify that only a portion of a payment amount to a payee associated with the payment request be debited on the debit date specified in the identified PSD payment schedule while the remaining portion of the payment amount be debited in accordance with standard payment processing (e.g., in associated with the date of crediting). Referring again to block 512, if, on the other hand, it is determined that the payment request does not satisfy at least one applicable payment parameter, a third determination may be made at block 514 as to whether an overage funds transfer (either payee-specific or for all payees) has been pre-approved, and whether pre-approval of such a funds transfer would satisfy those payment parameter(s) that were determined to be violated by the payment request. If it is determined that an overage funds transfer would satisfy violated payment parameters, the processing 500 may proceed to block 516 where an overage funds transfer may be scheduled.

The overage funds transfer may be scheduled from a pre-specified account to the funding account associated with the payment request. In certain embodiments, the overage funds transfer may be credited to the funding account no later than the debit date. As noted earlier, the pre-specified account may be associated with a different financial institution than a financial institution with which the funding account is associated. The overage funds transfer may be accomplished as an intra-bank or inter-bank funds transfer or may correspond to a charge to a debit or credit card account performed across a credit or debit network. In the case of a charge to a credit or debit card account, the service provider associated the payment system 102 may debit the pre-specified account in an amount of the overage funds and a credit may then be issued from the service provider to the payor's funding account.

In certain embodiments, a fee may be associated with an overdraft funds transfer or charge. The fee may be included in the debit/charge to the pre-specified account, may be levied against the same account but in a separate transaction, or may be levied against a different account (such as the payor's funding account for the payment request). Upon scheduling of the overage funds transfer or initiation of the overage funds charge, the payment request may be processed in accordance with PSD payment processing at block 512.

On the other hand, if it is determined that an overage funds transfer would not satisfy those payment parameter(s) violated by the payment request, one or more alternative payment options may be determined at block 518. The alternative payment options may be either transmitted to the payor as part of a notification message or presented to the payor in session. The alternative payment options may include for example, an option to cancel the payment request, an option to transfer overage funds from another funding account and proceed with payment, or an option to accept a fee increase and proceed with payment. In connection with the transfer of overage funds from another account, an option may be provided to the payor to designate the identified overage funding account as a one-time use account (in which case the account information may not be stored) or to designate the account as usable for future overage funds transfers (in which case the account information may be stored in association with the payee). Further, in connection with the option to accept a fee increase and proceed with payment, the payor may be provided with the option of incurring a one-time fee for the payment request without changing established payment parameters or an option of accepting a new permanent fee associated with persistent changes to established payment parameters.

Upon determination of the alternate payment processing options, a determination may be made as to whether the payor is still in session at block 520. If the payor is determined to not be in session, notification information identifying the alternative payment processing options may be transmitted to the payor. The notification information may include the alternate payment processing options as selectable options (e.g., the payor may be required to provide a response indicating selection of one option and, in some cases, providing further information). Upon receipt of the response from the payor indicating a selection of an alternative payment processing option, payment processing may be performed in accordance with the selected option. The notification information may take on any of a variety of forms and may be transmitted in accordance with any suitable available mechanism for interacting with the payor. For example, the notification information may be transmitted as part of an electronic mail message, a text message, a push notification, an automated telephone call, and so forth. The message may include information that identifies a mechanism by which a response may be submitted (e.g., by selecting a link that points to a URL, by including a short code in the response, etc.).

On the other hand, if it is determined that that the payor is still in session, the alternate payment processing options may be transmitted at block 524 for presentation to the payor as selectable options in session. At block 526, a response may be received on behalf of the payor. At block 528, the response may be processed. Processing of the response may involve modifying certain payment parameters of the PSD payment schedule that are associated with the current payee such as, for example, a maximum payment amount limit, default monthly payment date, one or more funding accounts, a per transaction fee, and so forth. Processing of the response may additionally, or alternatively, include modifying one or more payment parameters associated with the PSD payment schedule generally such as, for example, pricing, aggregate maximum payment amount limit for all payments to all payees, an aggregate number of days of debit deferral across all payees, and so forth.

At block 530, a determination may be made as to whether the response received on behalf of the payor indicates the payor's desire to cancel the current payment request. If it is determined that the response indicates a desire on the part of the payor to cancel the payment request, standard processing for canceling a payment request may be performed at block 532. In certain embodiments, if notification information is transmitted to the payor at block 522 and the payor does not respond within a certain timeframe, the payment system 102 may be configured to cancel the payment request.

On the other hand, if it is determined that the response does not indicate a desire to cancel the payment request, the processing 500 may proceed to block 534 where a determination may be made as to whether the response indicates that the option to identify a funding account for an overage funds transfer was chosen by the payor. In the event that a positive determination is made at block 534, the processing may proceed to block 516 where an overage funds transfer may be scheduled for the funding account identified in the response. On the other hand, if a negative determination is made at block 534, the processing 500 may proceed to block 508 and the payment request may be processed in accordance with standard payment processing.

If PSD payment processing is performed at block 512 as part of the processing 500, a debit may be scheduled against the payor's specified funding account for the debit date associated with the PSD payment schedule. A credit to the payee (paper or electronic) may also be scheduled for delivery to the payee on the payment date (e.g., a due date model) or may be scheduled to be issued pending good funds processing (e.g., a good funds model). In certain embodiments, debits scheduled for the same date against the same funding account may be accumulated and consolidated or issued as individual transactions. In addition, in various embodiments, the appropriate fee (either per transaction or “bundle pricing” associated with multiple transactions), as approved by the payor, may also be scheduled to be debited on the debit date. The fee may be charged as part of a debit scheduled against the funding account in connection with a payment transaction or as a separate debit transaction. Per transaction fees may be consolidated or handled individually.

As described above, in accordance with one or more embodiments of the disclosure, a PSD payment schedule proposal may be generated as part of payor enrollment for PSD payment processing. The PSD payment schedule proposal may include pricing information that may be determined on a per-transaction basis or as a bundled price for a set of payments. The PSD payment schedule proposal may be transmitted for presentation to a payor and the payor may be provided with a capability to cancel his/her enrollment, accept the proposal, or modify one or more characteristics of the proposal. In certain embodiments, the pricing information may include tiers of pricing. Tiered pricing may be available when bundle pricing is offered. As a non-limiting example, the payor may be provided with various tiered pricing options such as, for example, purchase options associated with different amounts of total scheduled debits (e.g., $250, $500, $750), purchase options associated with different total number of days of debit deferral (e.g., 15 days, 30 days, 50 days), and/or a combination thereof.

In addition to selecting a particular pricing tier, the payor may also be provided with a capability to identify a particular “singleton” payment request that is not already associated with a PSD payment schedule associated with the payor and request that the “singleton” payment request be included in a next debit associated with a PSD payment schedule. In certain embodiments, inclusion of the “singleton” payment in the PSD payment schedule may cause a total allowed payment amount to be exceeded, in which case, an incremental per-transaction fee may be incurred. Inclusion of a “singleton” payment in a PSD payment schedule may be desired, for example, when an immediate or same-day payment request is submitted.

In certain embodiments, a service provider and/or financial institution hosting the payment system 102 may be able to perform an analysis of a payor's bill payment history associated with a PSD payment schedule in order to identify potential issues and/or opportunities. For example, if payments associated with a PSD payment schedule of the payor's repeatedly result in overages or increased fee situations, the payment system 102 may determine that various remedial actions may need to be taken such as, for example, proposing new limits, preventing the payor from utilizing the PSD payment processing service, offering a short-term loan, and so forth. Conversely, if the payor's PSD payment history indicates acceptable or favored credit behavior, the payor may be determined to be a candidate for another bank product such as, for example, a home equity line of credit (HELOC), a consumer loan, a credit card account, and so forth. Such analyses may be combined with other analyses performed in connection with bill payment and/or core account data to identify potential opportunities for the payor. In certain embodiments, such as those in which a financial institution hosted the payment system 102, other accounts held by a payor at the financial institution may be identified and automatically designated as potential overage funding accounts for funding portions of payments that exceed available funds in primary funding accounts.

In certain embodiments, PSD payment processing may provide value to entities other than individual consumers such as, for example, small businesses having to pay suppliers or make payroll, and needing to “bridge” the gap between expected cash inflows. The PSD payment processing functionality would operate similarly for small businesses as for individual consumers; however, the risk management may be more involved and pricing may be higher as a result of the larger payments likely to be made in comparison to a typical consumer situation.

The operations described and depicted with respect to the illustrative processing of FIGS. 4A-5B may be carried out or performed in any suitable order as desired in various embodiments of the disclosure. Additionally, in certain embodiments, at least a portion of the operations may be carried out in parallel. Furthermore, in certain embodiments, less, more, or different operations than those depicted in FIGS. 4A-5B may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, although specific example embodiments have been presented, it should be appreciated that numerous other examples are within the scope of this disclosure.

Additional types of CRSM beyond those described previously that may be present in association with any of the components described herein (e.g., any of the components of the networked architecture 100) may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, solid-state memory devices, or any other medium. Combinations of any of the above are also included within the scope of CRSM.

Computer-readable communication media may include computer-readable instructions, program modules, or other data transmitted within a data signal, such as a carrier wave, or other transmission. Examples of computer-readable communication media, whether modulated using a carrier or not, include, but are not limited to, signals that a computer system or machine hosting or running a computer program can be configured to access, including signals downloaded through the Internet or other networks. For example, the distribution of software may be an Internet download. It is noted that, as used herein, CRSM does not include computer-readable communication media.

Although embodiments have been described in language specific to structural features and/or methodological acts, it is to be understood that the disclosure is not necessarily limited to the specific features or acts described. Rather, the specific features and acts are disclosed as illustrative forms of embodiments of the disclosure. Conditional language such as, for example, “can,” “could,” “might,” or “may,” unless specifically stated otherwise, or unless otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A system, comprising:
one or more datastores;
one or more network interfaces;
at least one memory storing computer-executable instructions; and
at least one processor communicatively coupled to the one or more network interfaces and the at least one memory and configured to access the at least one memory and execute the computer-executable instructions to:
receive, via the one or more network interfaces and on behalf of a payor, a request to enroll the payor in payor-scheduled-debit (PSD) payment processing;
direct the one or more network interfaces to transmit, for presentation to the payor, a first user interface that specifies one or more payment parameters and that enables receipt of one or more user-specified payment parameter values for association with an enrollment of the payor in the PSD payment processing, wherein the one or more payment parameters comprise a debit date parameter;
receive, via the one or more network interfaces, the one or more payment parameter values for association with the one or more payment parameters, wherein the one or more payment parameter values comprise a debit date parameter value indicating a debit date for debiting one or more financial accounts associated with the payor;
determine, based at least in part on the one or more payment parameter values, a set of one or more candidate payees;
direct the one or more network interfaces to transmit, for presentation to the payor, identifying second user interface that specifies the set of one or more candidate payees and that enables receipt of a user selection of at least one candidate payee from the set of one or more candidate payees;
receive, via the one or more network interfaces and on behalf of the payor, a selection of at least one candidate payee from the set of one or more candidate payees;
generate, based at least in part on the debit date and the selection of the at least one candidate payee, a proposed PSD payment schedule for debiting one or more payments to the at least one candidate payee on the debit date and crediting at least one of the one or more payments on a date that precedes or follows the debit date;
direct the one or more network interfaces to transmit, for presentation to the user, a third user interface that specifies the proposed PSD payment schedule and that enables receipt of a user approval, a user rejection, or a user modification of the proposed PSD payment schedule;
receive, via the one or more network interfaces, a response indicating approval of the proposed PSD payment schedule; and
generate a PSD payment schedule based at least in part on the proposed PSD payment schedule and responsive to receiving the response indicating approval of the proposed PSD payment schedule, wherein generating the PSD payment schedule comprises storing, by the computerized payment system in one or more datastores, the one or more payment parameter values in association with an identifier associated with the payor.

2. The system of claim 1, wherein the at least one processor is further configured to execute the computer-executable instructions to:
store, in the one or more datastores and in association with a respective identifier associated with each of the at least one candidate payee, an identifier associated with the PSD payment schedule indicating that each of the one or more payments from the payor to each of the at least one candidate payee are to be processed in accordance with the PSD payment schedule.

3. The system of claim 1, wherein the at least one processor is further configured to execute the computer-executable instructions to:
analyze, responsive to receipt of the request to enroll the payor in payor-scheduled-debit (PSD) payment processing, payment history information associated with the payor to generate one or more analysis results; and
determine, based at least in part on the one or more analysis results and prior to directing the one or more network interfaces to transmit the first user interface, that one or more eligibility conditions for enrollment of the payor in the PSD payment processing are satisfied.

4. The system of claim 3, wherein the one or more eligibility conditions comprise at least one of:
i) enrollment of the payor with a payment service provided by the system for a minimum number of months,
ii) a number of successful posted payments by the payor meeting or exceeding a first threshold;
iii) a number of failure incidents associated with payments made by the payor over a specified period of time meeting or being less than a second threshold,
iv) funds in one or more financial accounts associated with the payor meeting or exceeding a third threshold, or
vi) satisfaction of one or more constraints associated with the PSD payment processing and specified by a financial institution sponsor associated with the payor.

5. The system of claim 1, wherein the one or more payment parameter values further comprise at least one of:
i) a start date for a billing period to associate with the PSD payment schedule,
ii) a duration of the billing period, or
iii) one or more overage funding accounts.

6. The system of claim 1, wherein, to determine the set of one or more candidate payees, the at least one processor is further configured to execute the computer-executable instructions to determine that each candidate payee of the set of one or more candidate payees satisfies one or more candidacy criteria.

7. The system of claim 6, wherein, to determine that each candidate payee satisfies one or more candidacy criteria, the at least one processor is further configured to execute the computer-executable instructions to at least one of:
i) determine that payments are received from the payor for each candidate payee based on a respective recurring payment model,
ii) determine that electronic billing has been activated for each candidate payee, or
iii) determine that a threshold number of months of respective payment history information for the payor is available for each candidate payee.

8. The system of claim 7, wherein the at least one processor is configured to execute the computer-executable instructions to determine that a threshold number of months of respective payment history information for the payor is available for each candidate payee, and wherein, to determine that each candidate payee satisfies one or more candidacy criteria, the at least one processor is further configured to execute the computer-executable instructions to determine, based at least in part on the respective payment history information for each candidate payee, at least one of:
i) that the payor made at least one payment to each candidate payee per month,
ii) that each of the at least one payment to each candidate payee is within a threshold number of days from a respective date each month for each candidate payee, or
iii) that a respective difference between a respective payment amount for each of the at least one payment and a fixed amount is within a threshold value.

9. The system of claim 1, wherein the set of one or more candidate payees comprises a second set of candidate payees, and wherein the at least one processor is further configured to execute the computer-executable instructions to:
determine, based at least in part on the one or more payment parameter selections, a first set of candidate payees; and
eliminate, a candidate payee from the first set of candidate payees based at least in part on one or more elimination rules to generate the second set of payees.

10. The system of claim 9, wherein, to eliminate the candidate payee from the first set of candidate payees based at least in part on the one or more elimination rules, the at least one processor is configured to execute the computer-executable instructions to at least one of:
i) determine that the candidate payee corresponds to the payor,
ii) determine that the candidate payee is associated with a same address as the payor,
iii) determine that the candidate payee has a same last name as the payor,
iv) determine that the candidate payee is a non-electronic payee,
v) determine that the candidate payee is a non-reversible payee, or
vi) determine that the candidate payee is associated with a prohibited category.

11. The system of claim 1, wherein the at least one processor is further configured to execute the computer-executable instructions to:
identify payment history information associated with the payor and one or more risk criteria for assessing a risk associated with the payor;
perform risk processing based at least in part on the payment history information and the one or more risk criteria to determine the risk associated with the payor;
determine that the risk associated with the payor is acceptable based at least in part on the risk processing; and
determine that the payor is eligible for enrollment in the PSD payment processing based at least in part on determining that the risk associated with the payor is acceptable.

12. The system of claim 11, wherein the at least one processor is further configured to execute the computer-executable instructions to:
identify one or more risk mitigating factors that mitigate the risk associated with the payor; and
perform the risk processing further based at least in part on the one or more risk mitigating factors.

13. The system of claim 12, wherein the one or more risk mitigating factors comprise at least one of:
i) one or more attributes associated with a candidate payee of the set of one or more candidate payees,
iv) a type of account specified by the payor for overage funds transfers,
v) whether the payor has activated electronic billing for the candidate payee,
vi) whether the payor has established a recurring payment model or autopay schedule for the candidate payee, or
vii) past payment behavior of the payor for the candidate payee.

14. The system of claim 11, wherein, to generate the proposed PSD payment schedule, the at least one processor is configured to execute the computer-executable instructions to:
generate pricing information based at least in part on the risk associated with the payor; and
associate the pricing information with the proposed PSD payment schedule.

15. A method, comprising:
receiving, by a computerized payment system comprising one or more computers and on behalf of a payor, a request to enroll the payor in payor-scheduled-debit (PSD) payment processing;
transmitting, by the computerized payment system for presentation to the payor, a first user interface that specifies one or more payment parameters and that enables receipt of one or more user-specified payment parameter values for association with an enrollment of the payor in the PSD payment processing, wherein the one or more payment parameters comprise a debit date parameter;
receiving, by the computerized payment system, the one or more payment parameter values for association with the one or more payment parameters, wherein the one or more payment parameter values comprise a debit date parameter value indicating a debit date for debiting one or more financial accounts associated with the payor;
determining, by the computerized payment system and based at least in part on the one or more payment parameter values, a set of one or more candidate payees;
transmitting, by the computerized payment system for presentation to the payor, identifying second user interface that specifies the set of one or more candidate payees and that enables receipt of a user selection of at least one candidate payee from the set of one or more candidate payees;
receiving, by the computerized payment system on behalf of the payor, a selection of at least one candidate payee from the set of one or more candidate payees;
generating, by the computerized payment system and based at least in part on the debit date and the selection of the at least one candidate payee, a proposed PSD payment schedule for debiting one or more payments to the at least one candidate payee on the debit date and crediting at least one of the one or more payments on a date that precedes or follows the debit date;
transmitting, by the computerized payment system for presentation to the user, a third user interface that specifies the proposed PSD payment schedule and that enables receipt of a user approval, a user rejection, or a user modification of the proposed PSD payment schedule;
receiving, by the computerized payment system on behalf of the payor, a response indicating approval of the proposed PSD payment schedule; and
generating, by the computerized payment system, a PSD payment schedule based at least in part on the proposed PSD payment schedule and responsive to receiving the response indicating approval of the proposed PSD payment schedule, wherein generating the PSD payment schedule comprises storing, by the computerized payment system in one or more datastores, the one or more payment parameter selections values in association with an identifier associated with the payor.

16. The method of claim 15, the method further comprising:
storing, by the computerized payment system in the one or more datastores and in association with a respective identifier associated with each of the at least one candidate payee, an identifier associated with the PSD payment schedule indicating that each of the one or more payments from the payor to each of the at least one candidate payee are to be processed in accordance with the PSD payment schedule.

17. The method of claim 15, further comprising:
analyzing, by the computerized payment system and responsive to receiving the request to enroll the payor in payor-scheduled-debit (PSD) payment processing, payment history information associated with the payor; and
determining, by the computerized payment system based at least in part on the analyzing and prior to transmitting the first user interface, that one or more eligibility conditions for enrollment of the payor in the PSD payment processing are satisfied based at least in part on the analyzing.

18. The method of claim 15, wherein the one or more payment parameter values further comprise at least one of:
i) a start date for a billing period to associate with the PSD payment schedule,
ii) a duration of the billing period, or
iii) one or more overage funding accounts.

19. The method of claim 15, further comprising:
identifying, by the computerized payment system, payment history information associated with the payor and one or more risk criteria for assessing a risk associated with the payor;
performing, by the computerized payment system, risk processing based at least in part on the payment history information and the one or more risk criteria to determine the risk associated with the payor;
determining, by the computerized payment system, that the risk associated with the payor is acceptable based at least in part on the risk processing; and
determining, by the computerized payment system, that the payor is eligible for enrollment in the PSD payment processing based at least in part on determining that the risk associated with the payor is acceptable,
wherein generating the proposed PSD payment schedule comprises:
generating, by the computerized payment system, pricing information based at least in part on the risk associated with the payor; and
associating, by the computerized payment system, the pricing information with the proposed PSD payment schedule.

20. The method of claim 19, further comprising:
identifying, by the computerized payment system, one or more risk mitigating factors that mitigate the risk associated with the payor; and
performing, by the computerized payment system, the risk processing further based at least in part on the one or more risk mitigating factors.
